(19) United States
(12) Patent Application Publication
(10) Pub. No.: US 2021/0067649 A1
(43) Pub. Date: Mar. 4, 2021

(54) IMAGE INSPECTION APPARATUS, IMAGE FORMING APPARATUS, IMAGE INSPECTION METHOD, AND PROGRAM

(71) Applicant: Konica Minolta Inc., Tokyo (JP)

(72) Inventor: Ryousuke OKAJIMA, Tokyo (JP)

(21) Appl. No.: 16/928,550

(22) Filed: Jul. 14, 2020

(30) Foreign Application Priority Data
Aug. 26, 2019 (JP) 2019-153427

(51) Int. Cl. H04N 1/00

(52) U.S. Cl. CPC H04N 1/00809; H04N 1/00639; H04N 1/00806

(57) ABSTRACT

An image inspection apparatus includes: an image reader that performs processing of reading conveyed paper as an image for a correct answer image and an image to be inspected; an information acquirer that acquires setting information at a time of forming an image of paper conveyed to the image reader; a storage that saves, as a correct answer image, an image read by the image reader as an image for a correct answer image, and saves the setting information; and a hardware processor that performs inspection by comparing an image to be inspected read by the image reader to a correct answer image stored in the storage.

The entire disclosure of Japanese patent Application No. 2019-153427, filed on Aug. 26, 2019, is incorporated herein by reference in its entirety.

### BACKGROUND

### Technological Field

The present invention relates to an image inspection apparatus, an image forming apparatus, an image inspection method, and a program.

### Description of the Related Art

Various inspection apparatuses for inspecting an image printed on paper have been developed. In such an inspection apparatus, a correct answer image is preliminarily registered. The inspection apparatus reads paper immediately after being subject to printing performed by an image forming apparatus with an image sensor. The inspection apparatus compares the read image and the correct answer image. When there is difference, the inspection apparatus determines that printing failure has occurred.

JP 2005-271331 A discloses a technique of inspection. In the technique, the first copy of a print job is printed and output. The output paper is read and registered in the printed order by an inspection apparatus. At the time of printing second and subsequent copies, correct answer images are read, and comparison is performed in the read page order.

When an image forming apparatus performs printing, there is a case where only a small number of copies are printed as needed in addition to a case where copies of a large number determined by a print job are continuously printed. For example, in the case of printing a large amount of printed matter of multiple pages, when an image forming apparatus performs printing, printing on paper is performed in an order from the first page (forward order). The printed paper is conveyed to a post-processing apparatus for performing bindery operation for each copy. Bindery operation such as stapling for each copy is performed. Printed matter is then completed.

In contrast, when printed paper is discharged to a paper discharging tray of an image forming apparatus without using a post-processing apparatus, printing needs to be performed in the reverse order from the last page so that sheets of paper are stacked on the paper discharging tray in the correct page order.

As described above, in the case of printing printed matter of multiple pages, there are cases of printing in the forward order and printing in the reverse order depending on setting of an image forming apparatus and the number of print copies.

When an inspection apparatus performs inspection, a correct answer image is preliminarily registered so that the order of printing and that of inspection coincide.

For example, it is assumed that the printing order at the time when an image forming apparatus prints a document G of N pages (N is an integer of 2 or more) is in a forward direction of documents G(1), G(2), G(3), . . . G(N−1), and G(N) as illustrated in FIG. 14A.

At this time, as illustrated in FIG. 14B, the documents G(1), G(2), G(3), . . . G(N−1), and G(N) are saved in the page order of the same forward direction as correct answer images in an image inspection apparatus that inspects a document immediately after being printed by the image forming apparatus.

In contrast, when the printing order in the image forming apparatus is in the reverse direction, opposite to the forward direction in FIG. 14A, from the last page to the top page, the image inspection apparatus needs to sequentially save the documents G(N), G(N−1), . . . G(2), and G(1) in the page order of reverse direction as correct answer images as illustrated in FIG. 14C.

As described above, the image inspection apparatus needs correct answer images corresponding to the printing order in the image forming apparatus to be registered for inspection. If the printing order in the image forming apparatus is changed from the order at the time of registering the correct answer images, inspection cannot be correctly performed.

Although a page order has been described here as a problem at the time of inspection using a correct answer image, the paper orientation of a correct answer image and that of a print image need to match. That is, when an image forming apparatus performs printing, there are two cases. In one case, printing is performed with a short side of paper being in a lateral direction. In the other case, printing is performed with a long side of paper being in a lateral direction. If the orientation of a correct answer image first registered at an image inspection apparatus and the orientation at which the image forming apparatus performs printing on paper do not match, the image inspection apparatus cannot correctly perform inspection.

### SUMMARY

An object of the invention is to provide an image inspection apparatus, an image forming apparatus, an image inspection method, and a program that can correctly perform inspection even if print settings of a page order and the like are different from those at the time of registering a correct answer image in the case where a print image is inspected by comparison to the correct answer image.

To achieve the abovementioned object, according to an aspect of the present invention, an image inspection apparatus reflecting one aspect of the present invention comprises: an image reader that performs processing of reading conveyed paper as an image for a correct answer image and an image to be inspected; an information acquirer that acquires setting information at a time of forming an image of paper conveyed to the image reader; a storage that saves, as a correct answer image, an image read by the image reader as an image for a correct answer image, and saves the setting information; and a hardware processor that performs inspection by comparing an image to be inspected read by the image reader to a correct answer image stored in the storage.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a configuration diagram illustrating an example of an entire image forming system according to a first embodiment of the invention;

FIG. 2A is a side view illustrating an example of the configuration of a post-processing apparatus according to the first embodiment of the invention;

FIG. 2B is a top view illustrating an example of the configuration of the post-processing apparatus according to the first embodiment of the invention;

FIG. 3 is a block diagram illustrating an example of the hardware configuration of a controller of an image inspection apparatus according to the first embodiment of the invention;

FIG. 4 illustrates an example of an operation screen at the time of registering a correct answer image according to the first embodiment of the invention;

FIG. 5 is a flowchart illustrating an example of processing of saving a correct answer image according to the first embodiment of the invention;

FIG. 6 illustrates an example of an operation screen at the time of inspection according to the first embodiment of the invention;

FIG. 7 is a flowchart illustrating an example of image inspection processing according to the first embodiment of the invention;

FIGS. 8A to 8C illustrate examples of an output direction of a correct answer image and an output direction of an inspection image according to the first embodiment of the invention;

FIGS. 9A and 9B illustrate examples of a correct answer image and a read image according to the first embodiment of the invention;

FIG. 10 illustrates an example at the time of variable printing according to the second embodiment of the invention;

FIG. 11 is a flowchart illustrating an example of processing of saving a correct answer image at the time of variable printing according to the second embodiment of the invention;

FIG. 12 is a flowchart illustrating an example of image inspection processing according to the second embodiment of the invention;

FIGS. 13A to 13C illustrate examples of a correct answer image and a read image at the time of variable printing according to another embodiment of the invention; and

FIGS. 14A to 14C illustrate an example of traditional settings of a document page order.

### DETAILED DESCRIPTION OF EMBODIMENTS

Hereinafter, one or more embodiments of the present invention will be described with reference to the drawings. However, the scope of the invention is not limited to the disclosed embodiments.

### 1. First Embodiment

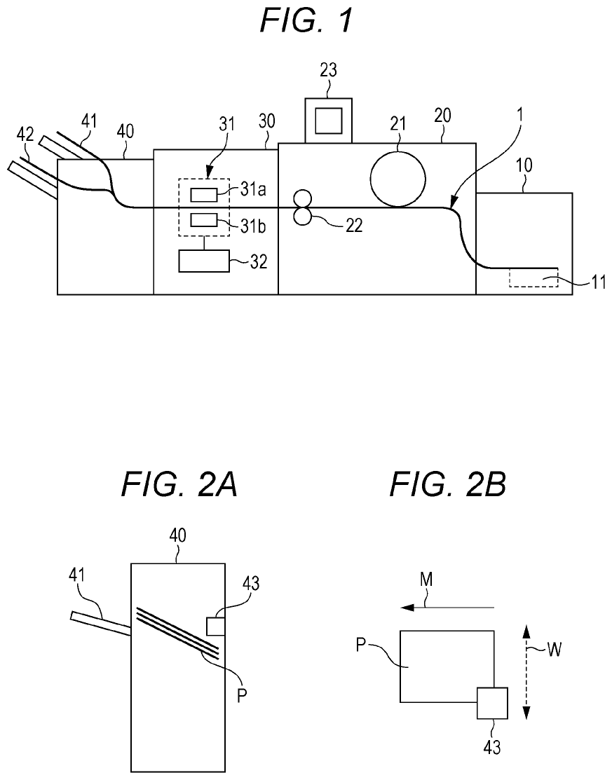

A first embodiment of the invention will be described below with reference to FIGS. 1 to 9B.

[1-1. Example of System Configuration]

FIG. 1 illustrates an example of the configuration of an image forming system according to the embodiment.

The image forming system according to the embodiment includes a paper feeding apparatus 10, an image forming apparatus 20, an image inspection apparatus 30, and a post-processing apparatus 40.

The paper feeding apparatus 10, the image forming apparatus 20, the image inspection apparatus 30, and the post-processing apparatus 40 are arranged in a line. A paper conveyance path 1 is provided inside each of the apparatuses 10, 20, 30, and 40. Paper fed from the paper feeding apparatus 10 is conveyed to the post-processing apparatus 40 through the paper conveyance path 1.

A paper feeding tray 11 is disposed in the paper feeding apparatus 10. Paper pulled out from the paper feeding tray 11 to the paper conveyance path 1 is supplied to the image forming apparatus 20.

The image forming apparatus 20 includes a developing unit 21 and a fixing unit 22. In the image forming apparatus 20, the developing unit 21 forms a toner image on a front or back side of the paper conveyed through the paper conveyance path 1, and the fixing unit 22 fixes the formed image. A paper reversing mechanism (not illustrated) is disposed in the middle of the paper conveyance path 1 inside the image forming apparatus 20, so that an image can be formed on both of front and back sides.

The image forming apparatus 20 also includes an operation unit 23. The operation unit 23 includes a touch panel for displaying an operation screen. The image forming apparatus 20 receives document data from a terminal apparatus (not illustrated), and performs printing on paper by using the document data. At this time, the image forming apparatus 20 also receives various pieces of setting information at the time of printing from the terminal apparatus, and performs printing based on the received setting information. For example, the setting information gives an instruction on a page order or paper orientation at the time of printing.

Paper having an image formed by the image forming apparatus 20 is conveyed to the image inspection apparatus 30 through the paper conveyance path 1.

The image inspection apparatus 30 includes an image reader 31 and an inspection processor 32. The image reader 31 includes a front-side sensor 31a and a back-side sensor 31b. When the paper subjected to printing at the image forming apparatus 20 is conveyed through the paper conveyance path 1, the image reader 31 scans the front and back sides of the paper to acquire a scan image.

The inspection processor 32 inspects printed matter based on the scan image obtained at the image reader 31. Specific processing of inspection will be described later in detail. Briefly speaking, the inspection processor 32 first saves a scan image of the first copy of printed matter as a correct answer image. When the image forming apparatus 20 prints second and subsequent copies, the inspection processor 32 inspects whether printing is correctly performed by comparing scan images of the printed matter of the second and subsequent copies to the correct answer image.

The paper that has been inspected at the image inspection apparatus 30 is conveyed to the post-processing apparatus 40 through the paper conveyance path 1.

The post-processing apparatus 40 includes a plurality of paper discharging trays 41 and 42. For example, the post-processing apparatus 40 outputs the printed matter determined to have no abnormality by an inspection at the image inspection apparatus 30 to one paper discharging tray 41, and outputs the printed matter determined to have an abnormality by an inspection at the image inspection apparatus 30 to the other paper discharging tray 42.

The post-processing apparatus 40 also includes a mechanism for performing various pieces of post-processing on printed paper. That is, as illustrated in FIGS. 2A and 2B, a stapler 43 is disposed inside the post-processing apparatus 40.

As illustrated in the side view of FIG. 2A, the stapler 43 staples sheets of output paper P stored in the post-processing apparatus 40 one by one.

As illustrated in the front view of FIG. 2B, the stapler 43 can move in a direction W orthogonal to a paper discharging direction M of the output paper P. The stapler 43 can staple sheets of output paper P both near the centers of end sides and at corners of the end sides of the output paper P.

The post-processing apparatus 40 includes a punch for punching a hole and a mechanism for folding paper (both not illustrated). The processing in the stapler 43, the punch, and the folding mechanism is performed based on, for example, an operation instruction from the operation unit 23 of the image forming apparatus 20.

[1-2. Example of Hardware Configuration of Inspection Processor]

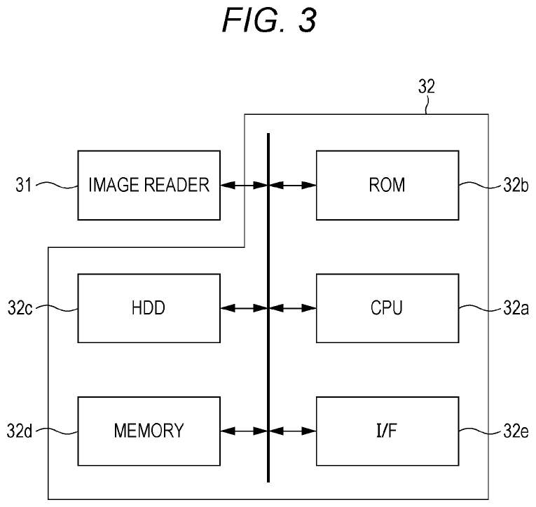

FIG. 3 illustrates an example of the hardware configuration of the inspection processor 32 of the image inspection apparatus 30.

The inspection processor 32 includes a computer.

That is, the inspection processor 32 includes a central processing unit (CPU) 32a, a read only memory (ROM) 32b, a hard disk drive (HDD) 32c, a memory 32d, and an interface 32e. These components are connected to each other via a bus line so that data can be transferred.

The image reader 31 is also connected to the bus line of the inspection processor 32.

The CPU 32a is an arithmetic processor that reads and executes a program code of software for implementing a function of performing image comparison processing and processing of creating a correct answer image from, for example, the ROM 32b.

Program codes for implementing various functions of the inspection processor 32 are stored in the ROM 32b.

In the HDD 32c, data of a correct answer image and data of an image to be inspected are stored, and processing of storing these pieces of data is performed.

The memory 32d is a work memory used to read a processing program stored in the ROM 32b.

The interface 32e is used for data transfer with the image forming apparatus 20 and the post-processing apparatus 40, or data transfer with an external network. For example, when an inspection is performed, the interface 32e acquires information on print setting for printed paper to be conveyed to the image reader 31 of the image inspection apparatus 30 from the image forming apparatus 20. The interface 32e thus functions as a setting information acquirer that performs processing of acquiring setting information regarding printing. The setting information regarding printing acquired ty the interface 32e is stored in the HDD 32c serving as a storage.

The configuration of the image forming system in FIGS. 1 to 3 is one example, and other configurations may be adopted. For example, the image inspection apparatus 30 may be provided with only the image reader 31. An image read by the image reader 31 may be sent to the side of the image forming apparatus 20. The image forming apparatus 20 may perform inspection processing. That is, the image read by the image reader 31 can be stored in a storage in the image forming apparatus 20. An arithmetic processor in the image forming apparatus 20 can perform inspection processing. Alternatively, the inspection processing may be performed on the side of a server connected to the image forming system in FIG. 1 via a network.

Dedicated hardware such as a field programmable gate array (FPGA) and an application specific integrated circuit (ASIC) may implement a part or all of the functions implemented by the inspection processor 32 of the image inspection apparatus 30.

[1-3. Processing of Saving Correct Answer Image]

Inspection processing performed by the image inspection apparatus 30 will now be described.

When performing an inspection, the image inspection apparatus 30 first performs processing of saving a correct answer image. That is, the image inspection apparatus 30 provides an item for giving an instruction to register a correct answer image as a print setting by using, for example, a printer driver or an application for printing provided in the image forming apparatus 20. The image inspection apparatus 30 gives an instruction to register a correct answer image by user operation. The image inspection apparatus 30 thereby performs processing of saving a correct answer image.

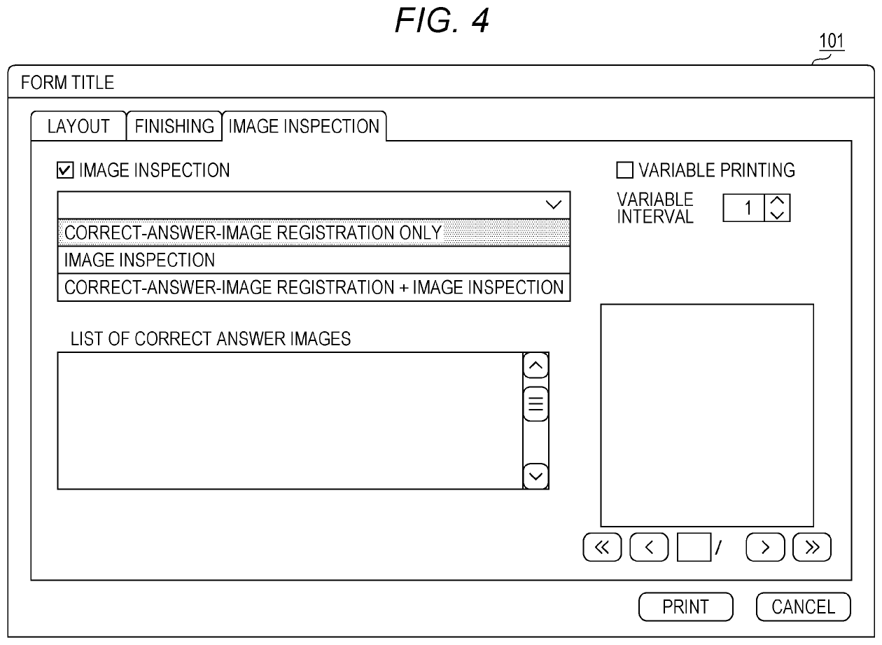

FIG. 4 illustrates one example of a print setting screen displayed on a terminal apparatus for performing print setting. A screen for print setting in FIG. 4 may be displayed on the operation unit 23 of the image forming apparatus 20 instead of on a terminal apparatus to which document data is sent.

Tabs of layout, finishing, and image inspection for printing are provided on an operation screen 101 in FIG. 4. The operation screen 101 in FIG. 4 illustrates a display example in the case where the tab of image inspection is selected. As illustrated in FIG. 4, the operation screen 101 includes an item of image inspection and an item of variable printing. In the item of image inspection, any of correct-answer-image registration only, image inspection, and correct-answer-image registration+image inspection is selected. In the item of variable printing, presence or absence of variable printing is selected.

FIG. 4 illustrates an example in which a user selects “correct-answer-image registration only”.

When an instruction to perform printing is given after “correct-answer-image registration only” is selected in the tab of image inspection, the image forming apparatus 20 starts to print a document on paper, and registers the document printed on the paper as a correct answer image.

When an instruction to perform printing is given, the image forming apparatus 20 performs processing of converting provided document data into a page-description language (PDL) by using a printer driver or an application for printing. At this time, print setting information containing registration instruction setting of a correct answer image is given by the printer driver or the application for printing. Document data for printing is transmitted to the image forming apparatus 20 via a network. The image forming apparatus 20 that receives the document data converts the received document data, and performs processing of obtaining image data in units of pages while setting, for example, the page of each piece of image data and a printing direction based on the print setting information.

The image forming apparatus 20 performs printing on paper by using the obtained image data in units of pages. Every time printing of the first copy is performed on the paper, the image inspection apparatus 30 performs processing of saving a correct answer image.

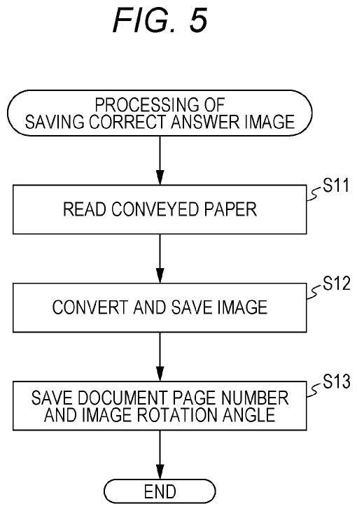

FIG. 5 is a flowchart illustrating the flow of processing of saving a correct answer image.

When the processing of saving a correct answer image is started, the image reader 31 reads paper conveyed from the image forming apparatus 20 to the image inspection apparatus 30 via the paper conveyance path 1 (Step S11). In the case where one side (front side) of the conveyed paper is printed by the image forming apparatus 20, the front-side sensor 31a reads the conveyed paper. In the case where both sides (front and back sides) are printed by the image forming apparatus 20, the front-side sensor 31a and the back-side sensor 31b read the conveyed paper.

The image data read by the image reader 31 is converted into image data for saving by the inspection processor 32, and stored in the HDD 32c as data of a correct answer image (Step S12). At the time of saving, the inspection processor 32 adds the document page number and setting information at the time of printing to the data of a correct answer image (Step S13). The setting information at the time of printing contains at least information on the document page number and information on the orientation (rotation angle) of the document.

When the data of a correct answer image is saved in Step S12, a file in an image file format for display, such as TIFF or JPEG, may also be generated from the read correct answer image, and saved. When the correct answer image is selected, the correct answer image can be displayed on a screen.

The processing of saving a correct answer image in the flowchart of FIG. 5 is performed on all pages.

For example, the followings indicate setting information at the time of printing saved together with a correct answer image.
Output order (either of forward order: 1 to N or reverse order: N to 1)
Document orientation
One side or both sides
Output orientation
Rotation
Presence or absence of staple
Presence or absence of punch
Presence or absence of folding
Paper feeding orientation

These pieces of setting information are saved together with a correct answer image in Step S13.

[1-4 Image Inspection Processing]

Processing of the image inspection apparatus 30 inspecting an image printed on paper by the image forming apparatus 20 will now be described.

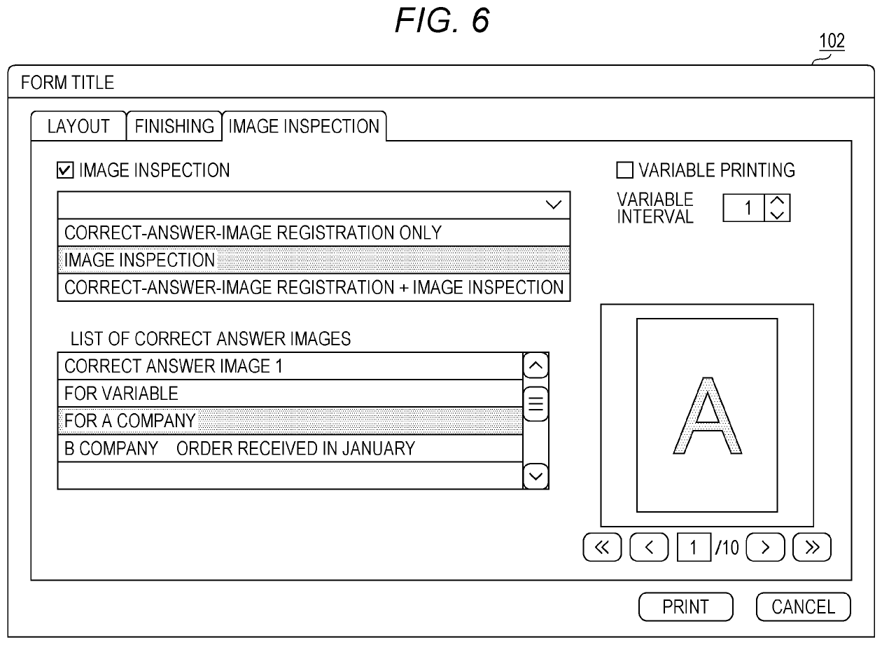

FIG. 6 illustrates one example of a print setting screen on a terminal apparatus for performing print setting. The print setting screen used at the time of image inspection may also be displayed on the operation unit 23 of the image forming apparatus 20.

Tabs of layout, finishing, and image inspection for printing are provided on an operation screen 102 in FIG. 6. FIG. 6 illustrates an example of displaying the operation screen 102 in the case where the tab of image inspection is selected.

As with the operation screen 101 in FIG. 4, the operation screen 102 in FIG. 6 includes an item of image inspection and an item of variable printing. In the item of image inspection, any of correct-answer-image registration only, image inspection, and correct-answer-image registration+image inspection is selected. In the item of variable printing, presence or absence of variable printing is selected.

FIG. 6 illustrates an example in which a user selects “image inspection” on the operation screen 102.

As illustrated in FIG. 6, when “image inspection” is selected, a list of correct answer images saved in the HDD 32c is displayed in a field for a list of correct answer images. FIG. 6 illustrates an example in which correct answer images of “for A company” are selected on the operation screen 102. The correct answer images of “for A company” are reduced and displayed page by page at the lower right of the operation screen 102. The reduced and displayed correct answer images can be switched for displaying another page by operating a page feeding button on the operation screen 102. In display of the correct answer images on the screen, image data for display that has been simultaneously stored at the time of storing correct answer images is used.

When an instruction to perform printing is given on the operation screen 102, the image forming apparatus 20 starts to print the required number of copies of specified document (document of a correct answer image) on paper at print settings at that time. Following the printing at the image forming apparatus 20, the image inspection apparatus 30 inspects the printed image. At the time of the inspection, the image inspection apparatus 30 acquires an identification code (ID) for specifying a correct answer image and print setting information at that time via the image forming apparatus 20.

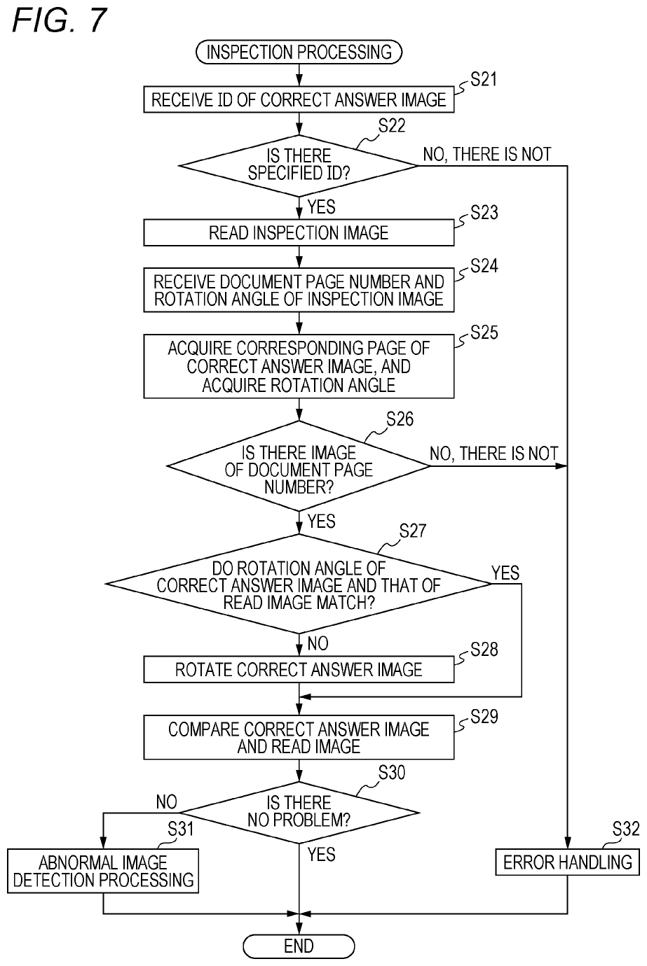

FIG. 7 is a flowchart illustrating the flow of image inspection processing performed at the image inspection apparatus 30.

The inspection processor 32 of the image inspection apparatus 30 first receives an identification code (ID) of a correct answer image selected on the operation screen 102 in FIG. 6 from the image forming apparatus 20 (Step S21). The inspection processor 32 determines whether the correct answer image of the specified identification code is saved in the HDD 32c (Step S22). When determining that the correct answer image does not exist in Step S22 (at the time of “No, there is not” in Step S22), the inspection processor 32 performs error handling (Step S32), and ends the inspection processing. In the error handling, for example, an error instruction is sent from the inspection processor 32 to the image forming apparatus 20. An error message is displayed on the operation unit 23 of the image forming apparatus 20 or a screen of a terminal that has given a print instruction.

When it is determined in Step S22 that the correct answer image exists (at the time of “YES” in Step S22), the image reader 31 reads conveyed paper (inspection image) (Step S23). The inspection processor 32 also receives the document page number and rotation angle information of the read inspection image based on the print setting information acquired via the image forming apparatus 20 (Step S24). The inspection processor 32 further acquires the correct answer image of the same document page number saved in the HDD 32c and the rotation angle information at the time of registering the correct answer image (Step S25).

The inspection processor 32 determines whether the correct answer image of the same document page number has been successfully read in the acquisition processing in Step S25 (Step S26). When it is determined in Step S26 that the correct answer image of the same document page number has not been successfully read (at the time of “No, there is not” in Step S26), the processing proceeds to the error handling in Step S32.

When it is determined in Step S26 that the correct answer image of the same document page number has been successfully read (at the time of “Yes” in Step S26), the inspection processor 32 determines whether the rotation angles match by comparing setting information of the correct answer image and setting information of the inspection image (Step S27). When it is determined in Step S27 that the rotation angles do not match (NO in Step S27), the inspection processor 32 rotates the correct answer image so that the correct answer image matches the inspection image (Step S28).

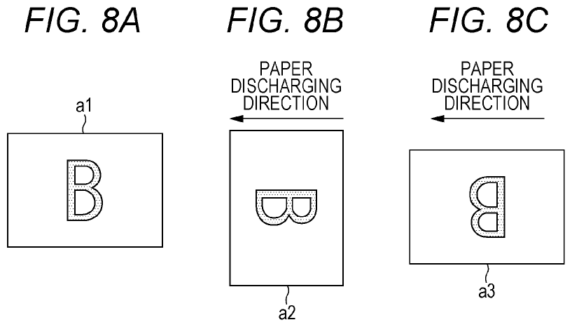

FIGS. 8A to 8C illustrate an example in which the rotation angle of a correct answer image and that of an inspection image do not match.

For example, paper a1 having a read correct answer image in FIG. 8A is a result of performing printing with the paper being placed in a landscape orientation.

As illustrated in FIG. 8B, when paper a2 on which an inspection image is printed is conveyed through the paper conveyance path 1 in a portrait orientation, the orientation of the correct answer image and that of the inspection image are determined not to match, and the orientation of the correct answer image is rotated by 90° in Step S28.

As illustrated in FIG. 8C, paper a3 on which the inspection image is printed is conveyed through the paper conveyance path 1 in the landscape orientation, the orientations of the correct answer image and the inspection image are rotated by 180°.

Returning to the description of the flowchart of FIG. 7, when it is determined in Step S27 that the rotation angles match (YES in Step S27), after the correct answer image is rotated in Step S28, the inspection processor 32 performs inspection processing of comparing the correct answer image and the inspection image (Step S29).

The inspection processor 32 determines whether the correct answer image and the inspection image match based on the inspection result in Step S29 (Step S30). When it is determined in Step S30 that the correct answer image and the inspection image match and there is no problem in the inspection result (YES in Step S30), the inspection processor 32 determines that printing has been correctly performed in the inspection for a corresponding page, and ends the inspection for the page.

When the correct answer image and the inspection image do not match, that is, when it is determined in Step S30 that there is a problem (NO in Step S30), the inspection processor 32 performs abnormal image detection processing (Step S31). At this time, the inspection processor 32 notifies the post-processing apparatus 40 of the inspection result, and causes the corresponding page to be discharged from a paper discharging tray 42 different from the paper discharging tray 41 for normal printing.

The inspection processor 32 performs the processing of Steps S21 to S32 in the flowchart of FIG. 7 all the time of page inspection.

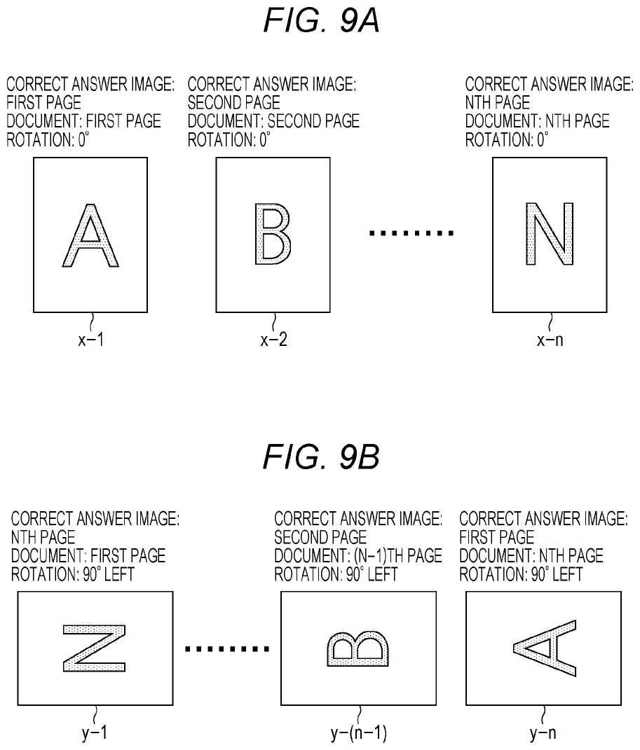

FIGS. 9A and 9B illustrate examples of the results of reading correct answer images and images to be inspected.

FIG. 9A illustrates saved correct answer images. The correct answer images here are arranged in the forward page order of the first page of image x-1, the second page of image x-2, . . . , and the Nth page of image x-n. Each image is printed at a rotation angle of 0° with a long side of paper being in a direction orthogonal to the conveyance direction.

FIG. 9B illustrates the results of reading images to be inspected. The images to be inspected here are printed in the reverse order. The first page of image y-1 of a document is defined as the final page (Nth page). Pages are then changed in the reverse direction. The Nth page of image y-n is defined as the first page. Printing is performed at a rotation angle of 90° left with a long side of paper being in a direction coincident with the conveyance direction.

In the case where the setting in FIG. 9B is used, and an image to be inspected is compared to a correct answer image in FIG. 9A, the inspection processor 32 arranges pages to be taken out as correct answer images in the reverse order so that the pages of the correct answer images are coincident with those of the images to be inspected. Processing of rotating a correct answer image itself by 90° left is performed.

An image to be inspected and a correct answer image can be compared in the state in which these images correspond to each other. According to the embodiment, a print image can be correctly inspected even when an image to be inspected is printed at print settings, in FIG. 9A, different from those in the case where a correct answer image is registered.

### 2. Second Embodiment

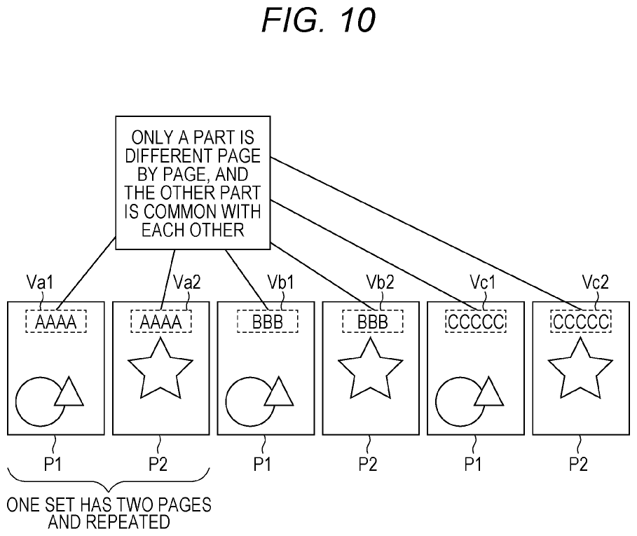

A second embodiment of the invention will now be described with reference to FIGS. 10 to 13C.

In the second embodiment, variable printing is performed. In the variable printing, print content in a part of range is different copy by copy (set by set). Each part of an image forming system has the same configuration as that described in the first embodiment, the description thereof will be omitted.

[2-1. Example of Variable printing]

FIG. 10 illustrates variable printing.

Here, one copy (one set) includes two pages of the first page P1 and the second page P2. Each of variable regions Va1, Va2, Vb1, Vb2, Vc1, Vc2, . . . are provided for each document. Different content is printed copy by copy in the variable regions Va1, Va2, Vb1, Vb2, Vc1, Vc2, . . . . The images of the first and second pages P1 and P2 are repeatedly printed in parts other than the variable regions.

When the variable printing is performed, for example, a user needs to check the item of “Variable printing” and input the number of repeated pages (variable interval) on a setting screen (FIG. 4 or 6).

[2-2. Processing of Saving Correct Answer Image]

Inspection processing in the case where the variable printing is performed in an image inspection apparatus 30 will now be described.

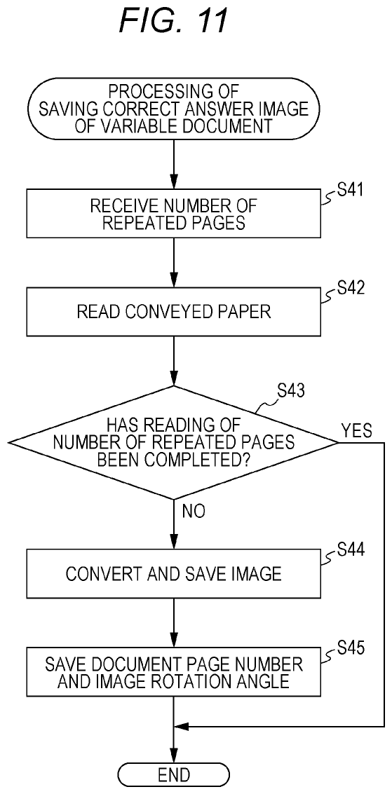

FIG. 11 is a flowchart illustrating the flow of processing of saving a correct answer image.

First, when the processing of saving a correct answer image is started, the image inspection apparatus 30 receives information of the number of repeated pages as the print setting information (Step S41). An image reader 31 reads paper conveyed from an image forming apparatus 20 to the image inspection apparatus 30 via a paper conveyance path 1 (Step S42). In the case where one side (front side) of the conveyed paper is printed, a front-side sensor 31a reads the conveyed paper. In the case where both sides (front and back sides) are printed, both the front-side sensor 31a and a back-side sensor 31b read the conveyed paper.

An inspection processor 32 determines whether reading of the number of repeated pages received in Step S41 has been completed (Step S43). When it is determined in Step S43 that the reading of the number of repeated pages has not been completed (NO in Step S43), the image data read in Step S42 is converted into image data for saving at the inspection processor 32, and is saved in an HDD 32c as data of a correct answer image (Step S44). At the time of saving, the inspection processor 32 adds the document page number and setting information at the time of printing to the data of a correct answer image (Step S45). The setting information at the time of printing contains at least information on the document page number and the orientation (rotation angle) of the document.

When it is determined in Step S43 that reading of the number of repeated pages has been completed (YES in Step S43), the inspection processor 32 ends the processing without performing the processing of saving a correct answer image. The processing of saving a correct answer image in the flowchart of FIG. 11 is performed on all pages.

[2-3 Image Inspection Processing]

Processing of the image inspection apparatus 30 in the case where the image inspection apparatus 30 inspects an image that has been printed on paper by the image forming apparatus 20 will now be described.

FIG. 12 is a flowchart illustrating the flow of image inspection processing performed at the image inspection apparatus 30.

The inspection processor 32 of the image inspection apparatus 30 first receives an identification code (ID) of a correct answer image from the image forming apparatus 20 (Step S51). The inspection processor 32 determines whether the correct answer image of the specified identification code is saved in the HDD 32c (Step S52). When the inspection processor 32 determines that the correct answer image does not exist in Step S52 (at the time of “No, there is not” in Step S52), the inspection processor 32 performs error handling (Step S64), and ends the inspection processing.

When it is determined in Step S52 that the correct answer image exists (at the time of “YES” in Step S52), the image reader 31 reads conveyed paper (inspection image) (Step S53). The inspection processor 32 also receives the document page number and rotation angle information of the read inspection image (Step S54). The inspection processor 32 further acquires the correct answer image of the same document page number saved in the HDD 32c and the rotation angle information at the time of registering the correct answer image (Step S55).

The inspection processor 32 calculates a remainder obtained by dividing the document page number by the number of repetition (repetition number) (Step S56). The inspection processor 32 treats the number obtained by adding “1” to the calculated remainder as the page number of the correct answer image (Step S57).

The inspection processor 32 determines whether the correct answer image of the document page number obtained in Step S57 has been successfully read (Step S58). When it is determined in Step S58 that the correct answer image of the same document page number has not been successfully read (at the time of “No, there is not” in Step S58), the processing proceeds to the error handling in Step S64.

When it is determined in Step S58 that the correct answer image of the same document page number has been successfully read (at the time of “Yes” in Step S58), the inspection processor 32 determines whether the rotation angles match by comparing setting information of the correct answer image and setting information of the inspection image (Step S59). When it is determined in Step S59 that the rotation angles do not match (NO in Step S59), the inspection processor 32 rotates the correct answer image so that the correct answer image matches the inspection image (Step S60).

In contrast, when it is determined in Step S59 that the rotation angles match (YES in Step S59), after the rotation in Step S60, the inspection processor 32 performs inspection processing of comparing the correct answer image and the inspection image (Step S61). At the time of comparison, regions other than the variable regions are compared, and variable regions are not compared.

The inspection processor 32 determines whether the correct answer image and the inspection image match based on the inspection result in Step S61 (Step S62). When it is determined in Step S62 that the correct answer image and the inspection image match and there is no problem in the inspection result (YES in Step S62), the inspection processor 32 determines that printing has been correctly performed in the inspection for a corresponding page, and ends the inspection for the page.

When it is determined in Step S62 that the correct answer image and the inspection image do not match and there is a problem (NO in Step S62), the inspection processor 32 performs abnormal image detection processing (Step S63). At this time, the inspection processor 32 notifies the post-processing apparatus 40 of the inspection result, and causes the corresponding page to be discharged from a paper discharging tray 42 different from the paper discharging tray 41 for normal printing.

The inspection processor 32 performs the processing of Steps S51 to S64 in the flowchart of FIG. 12 all the time of page inspection.

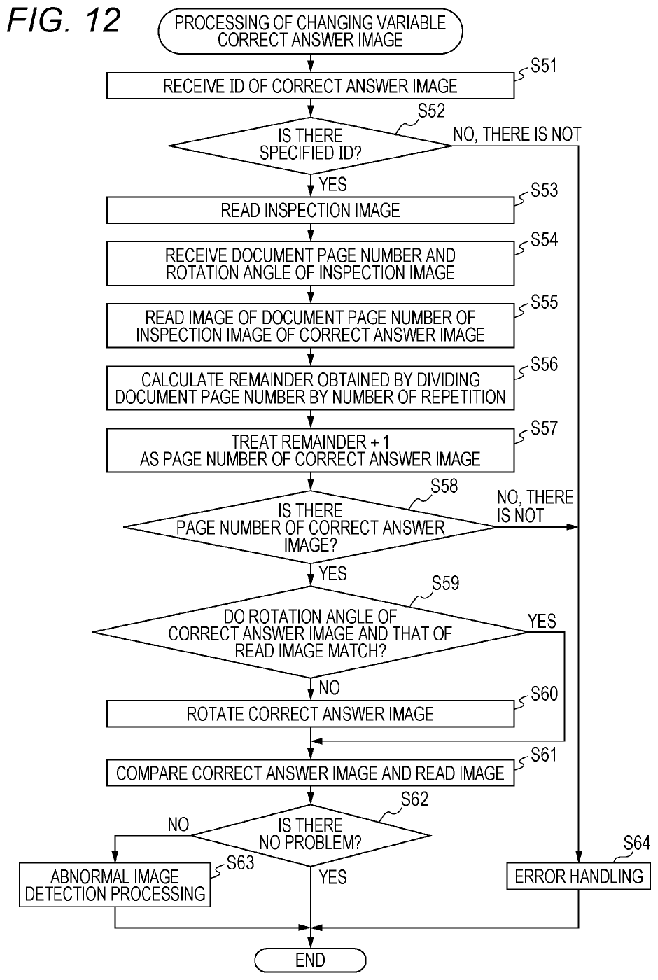

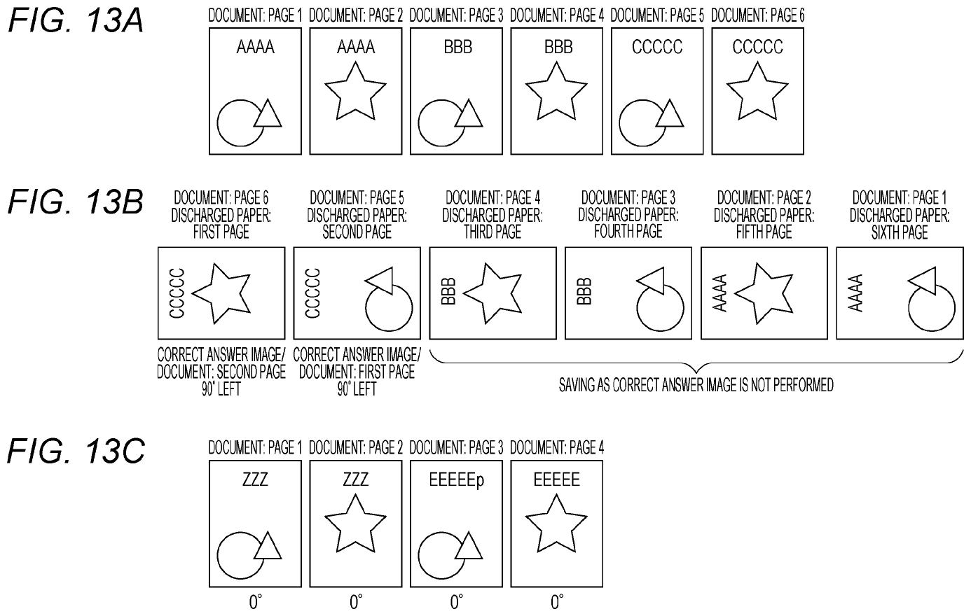

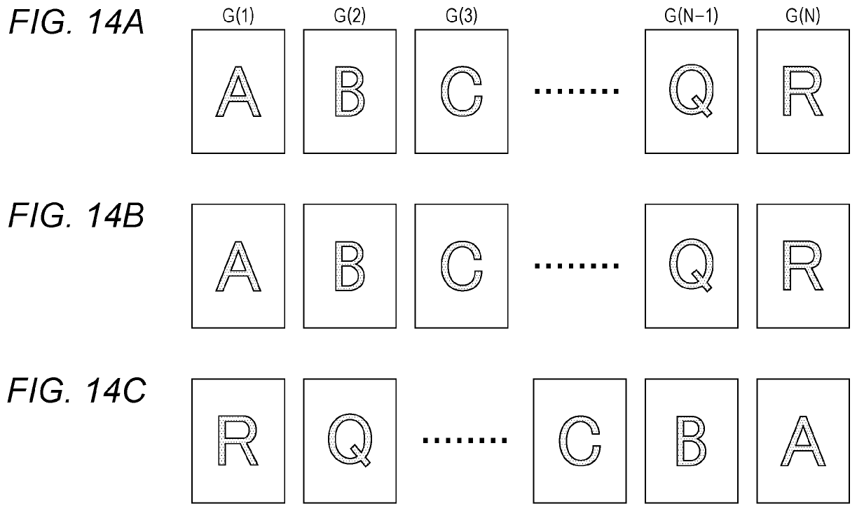

FIGS. 13A to 13C illustrate examples of the results of reading correct answer images and images to be inspected.

FIG. 13A illustrates documents at the time of registering correct answer images. Here, one set includes two pages. The same image content is repeated every two pages. Different contents are printed in variable regions for each set.

FIG. 13A illustrates the first to sixth pages. One set includes two pages, and thus only the top two pages are saved as correct answer images.

FIG. 13B illustrates examples of the output result at the time of registering the correct answer images and the images to be inspected.

Here, while the sixth to first pages are printed in the reverse order, each page is rotated by 90° to the left, and printed on paper.

At this time, the top page (first page of discharged paper) is compared to the second page of the correct answer images. The next page (second page of discharged paper) is compared to the first page of the correct answer images. At the time of the comparison, the correct answer images are rotated.

Afterward, until the last page, comparisons are performed by using these two pages of correct answer images.

FIG. 13C illustrates an example of a new job using the same correct answer images. In the new job in FIG. 13C, two sets (four pages) of printing are performed in the forward order at a rotation angle of 0°.

At this time, the top page (first page of discharged paper) is compared to the first page of the correct answer image. The next page (second page of discharged paper) is compared to the second page of the correct answer image. At the time of the comparison, the correct answer images are not rotated.

Afterward, until the last page, comparisons are performed by using these two pages of correct answer images.

Inspection processing in this way enables a document having a variable region to be correctly inspected.

### 3. Variations

An example in which a page order and a rotation angle are changed has been described during comparison of a correct answer image and an image to be inspected in the above-mentioned embodiment. In contrast, the correction processing may be performed at the time of comparison in accordance with another print setting.

For example, the print setting information includes staple setting of stapling sheets of paper, folding setting of folding paper, and punch setting for paper. Processing of correcting a correct answer image at the time of comparison may be performed by using at least any one of these pieces of setting information.

Although a case where only one side (front side) of paper is printed has been described in the processing of comparing a correct answer image and an image to be inspected in FIGS. 9A, 9B, and 13A to 13C, duplex printing can be performed by reading a corresponding document based on setting information for the duplex printing.

There has been described an example in which a candidate correct answer image is displayed on a screen page by page when a correct answer image is selected on the operation screen 102 in FIG. 6 and when any of candidate correct answer images is selected from a list of correct answer images. In contrast, display of reduced and arranged pages of the selected correct answer images, so-called thumbnail display may be performed so that all the correct answer images can be seen on a screen.

Although, in the system configuration in FIG. 1, the image forming apparatus 20 includes the developing unit 21 and the fixing unit 22, the system configuration may be applied to another image forming apparatus of, for example, inkjet method.

Furthermore, in the configuration in FIG. 1, the image inspection apparatus 30 and the image forming apparatus 20 are separate apparatuses. However, the image forming apparatus 20 may include the image inspection apparatus 30.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image inspection apparatus comprising:
an image reader that performs processing of reading conveyed paper as an image for a correct answer image and an image to be inspected;
an information acquirer that acquires setting information at a time of forming an image of paper conveyed to the image reader;
a storage that saves, as a correct answer image, an image read by the image reader as an image for a correct answer image, and saves the setting information; and
a hardware processor that performs inspection by comparing an image to be inspected read by the image reader to a correct answer image stored in the storage.

2. The image inspection apparatus according to claim 1,
wherein the hardware processor performs inspection while setting a correct answer image and an image to be inspected to have a same setting at a time of inspection based on setting information stored in the storage.

3. The image inspection apparatus according to claim 2,
wherein the setting information stored in the storage contains page information of a correct answer image, and
the hardware processor matches a page of the image to be inspected and a page of the correct answer image, and performs inspection.

4. The image inspection apparatus according to claim 2,
wherein the setting information stored in the storage contains information on a page order of a correct answer image, and
the hardware processor matches a page order of the image to be inspected and a page order of the correct answer image, and performs inspection.

5. The image inspection apparatus according to claim 2,
wherein the setting information stored in the storage contains information on orientation, a paper feeding direction, or a rotation state of a correct answer image, and
the hardware processor matches orientation, paper feeding direction, or rotation state of the image to be inspected and those of the correct answer image, and performs inspection.

6. The image inspection apparatus according to claim 2,
wherein the setting information stored in the storage contains at least any one of staple setting, paper folding setting, and paper punch setting, and
the hardware processor corrects the correct answer image or the image to be inspected based on the setting information, and performs inspection.

7. The image inspection apparatus according to claim 2,
wherein the setting information stored in the storage contains information on print setting of both sides or one side of paper, and
the hardware processor selects a paper side to be inspected based on the information on print setting of both sides or one side of paper.

8. The image inspection apparatus according to claim 2,
wherein the setting information stored in the storage contains information on a region where variable printing is performed, and
the hardware processor sets a region to be inspected based on the information on a region where variable printing is performed.

9. An image forming apparatus comprising the image inspection apparatus according to claim 1.

10. An image inspection method comprising:
reading conveyed paper as an image for a correct answer image and an image to be inspected;
acquiring setting information at a time of forming an image of paper subjected to the reading;
saving, as a correct answer image, an image read in the reading as an image for a correct answer image, and saving the setting information; and
performing inspection by comparing an image to be inspected read in the reading to a correct answer image stored in the saving.

11. A non-transitory recording medium storing a computer readable program causing a computer to perform:
reading conveyed paper as an image for a correct answer image and an image to be inspected;
acquiring setting information at a time of forming an image of paper subjected to the reading;
saving, as a correct answer image, an image read in the reading as an image for a correct answer image, and saving the setting information; and
performing inspection by comparing an image to be inspected read in the reading to a correct answer image stored in the saving.
